(19) United States
(12) Patent Application Publication
(10) Pub. No.: US 2025/0108830 A1
(43) Pub. Date: Apr. 3, 2025

(54) OPERATING LAW AWARE PLANNING CRITERIA FOR INTELLIGENT MACHINES AND NEURAL MOTION PLANNERS INTEGRATED WITH THE PLANNING CRITERIA

(71) Applicant: NVDIA Corporation, Santa Clara, CA (US)

(72) Inventors: Sushant Veer, Sunnyvale, CA (US); Apoorva Sharma, Oakland, CA (US); Karen Leung, Seattle, WA (US); Marco Pavone, Stanford, CA (US)

(21) Appl. No.: 18/652,473

(22) Filed: May 1, 2024

Related U.S. Application Data
(60) Provisional application No. 63/586,300, filed on Sep. 28, 2023.

(51) Int. Cl. B60W 60/00

(52) U.S. Cl. CPC B60W 60/001

(57) ABSTRACT

The disclosure provides a solution for intelligent machines, such as autonomous vehicles (AVs), that incorporate operating laws into motion planning by expressing complex operating laws along with other planning criteria under a single framework referred to herein as universal planning criteria (UPC). The UPC is expressed using a rule hierarchy approach, which allows for expressing individual operating rules, such as traffic rules, as signal temporal logic (STL) rules that are assigned an importance order. The STL rule hierarchy is advantageously equipped with a scalar rank-preserving reward function that can be differentiable and can be explicitly used for motion planning and/or embedding in neural motion planners. In one aspect the disclosure provides a method of operating an AV that includes: (1) scalably expressing traffic laws and additional planning criteria in a UPC framework, and (2) generating, using a neural motion planner and the UPC framework, a planned trajectory for the AV.

### CROSS REFERENCE TO RELATED APPLICATION

This application claims the benefit of U.S. Provisional Application Ser. No. 63/586,300, filed by Sushant Veer, et al., on Sep. 28, 2023, entitled “TRAFFIC LAW AWARE PLANNING CRITERIA FOR AUTONOMOUS VEHICLES AND EMBEDDING IT IN NEURAL MOTION PLANNERS,” commonly assigned with this application and incorporated herein by reference in its entirety.

### TECHNICAL FIELD

This application is directed, in general, to directing intelligent machines and, more specifically, to motion planning for the intelligent machines based on operating laws. For example, an intelligent machine can be an autonomous vehicle and the operating laws can be traffic laws.

### BACKGROUND

Intelligent machines have sufficient processing capability to independently perform tasks and operate in an environment according to rules or laws within the environment. In addition to the laws, intelligent machines may also satisfy various operating criteria. Autonomous vehicles (AVs), for example, need to obey rules of the road in accordance with the traffic laws in an area. In addition to obeying the traffic laws, AVs should also satisfy various other criteria, such as ensuring passenger comfort, progression towards goal, and courtesy towards other traffic agents. Obeying the traffic laws while satisfying other criteria can be challenging; especially since many AVs use neural motion planners for directing the trajectory (i.e., motion) of the AVs.

### SUMMARY

In one aspect, the disclosure provides a method of operating an AV. In one example, the method includes: (1) scalably expressing traffic laws and additional planning criteria in a UPC framework, and (2) generating, using a neural motion planner and the UPC framework, a planned trajectory for the AV.

In another aspect, the disclosure provides a method of operating a machine. In one example, the method of operating a machine includes: (1) representing operating laws in motion planning for the machine by scalably expressing the operating laws and other planning criteria in a UPC framework and embedding the UPC in a neural motion planner, (2) generating planned trajectories by the neural motion planner using the UPC, and (3) operating the machine using the planned trajectories.

In yet another aspect, the disclosure provides a control system for a machine. In one example, the control system includes: (1) one or more processing units configured to generate planned trajectories for the machine based on learning and operating laws for the machine represented by a UPC, and (2) a control unit configured to receive the planned trajectories and direct operation of the machine based on the planned trajectories.

The disclosure also provides a computer program product having a series of operating instructions stored on a non-transitory computer-readable medium that directs a data processing apparatus when executed thereby to perform operations to direct operation of an intelligent machine. In one example, the operations include: (1) scalably expressing traffic laws and additional planning criteria in a universal planning criteria (UPC) framework, wherein the scalably expressing includes expressing each rule of the traffic laws as a signal temporal logic (STL) formula, (2) generating, using a neural motion planner and the UPC framework, planned trajectories for the intelligent machine, and (3) directing movement of the intelligent machine using the planned trajectories.

In still yet another aspect, the disclosure provides a machine. In one example, the machine includes: (1) one or more operational domains, (2) a motion planner having one or more neural networks configured to generate planned trajectories for the machine based on operating laws for the machine represented by a UPC, and (3) a control unit having one or more processors configured to receive the planned trajectories and direct operation of the one or more operational domains using commands based on the planned trajectories.

### BRIEF DESCRIPTION

Reference is now made to the following descriptions taken in conjunction with the accompanying drawings, in which:

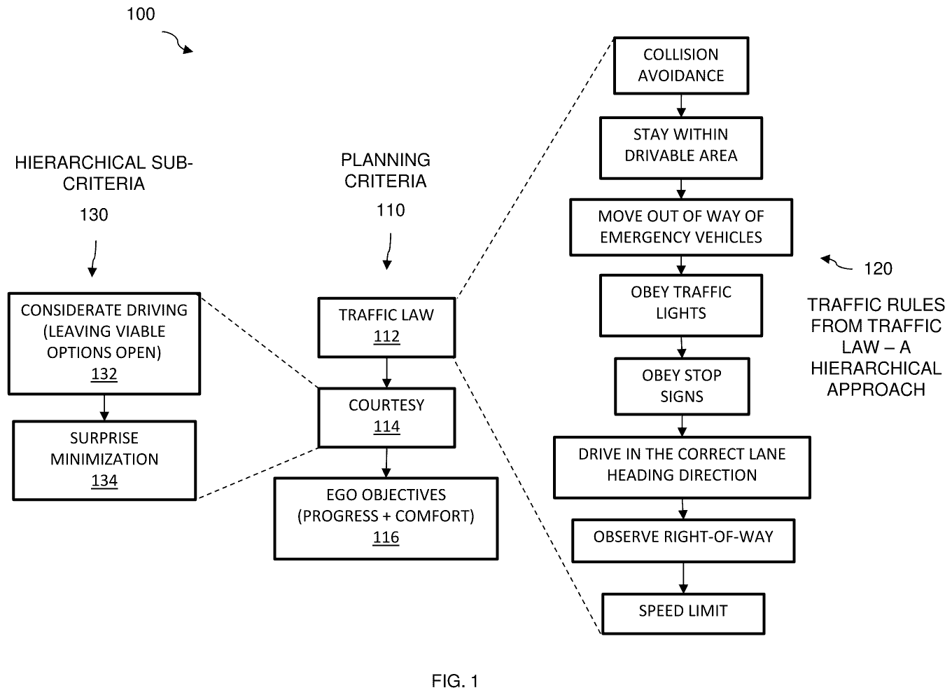

FIG. 1 provides a visual example of a UPC that includes three planning criteria for an ego AV to satisfy;

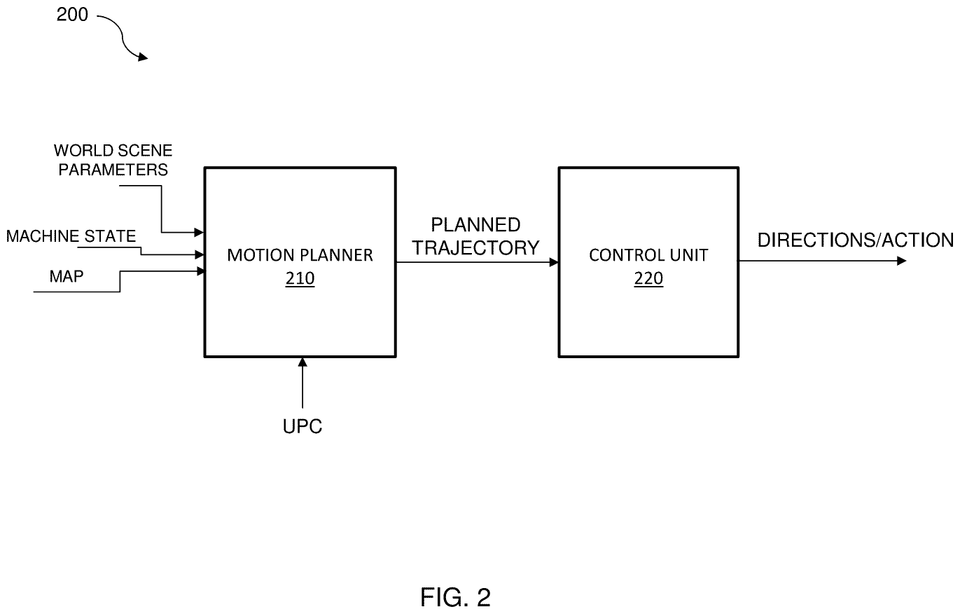

FIG. 2 illustrates a block diagram of an example of a control system for directing the operation of an intelligent machine according to the principles of the disclosure;

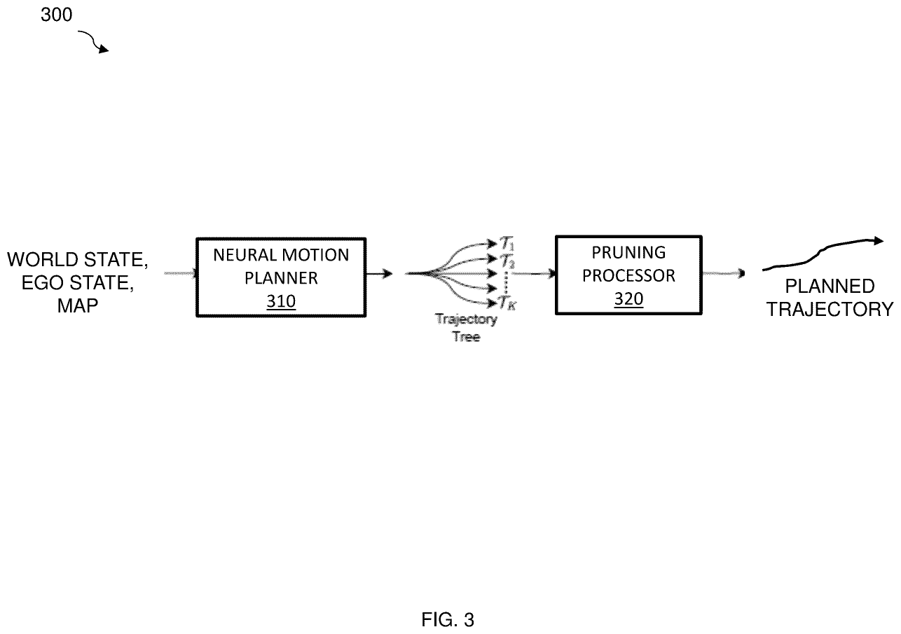

FIG. 3 illustrates an example of a motion planning system that uses Post-hoc Trajectory Pruning to obtain a planned trajectory;

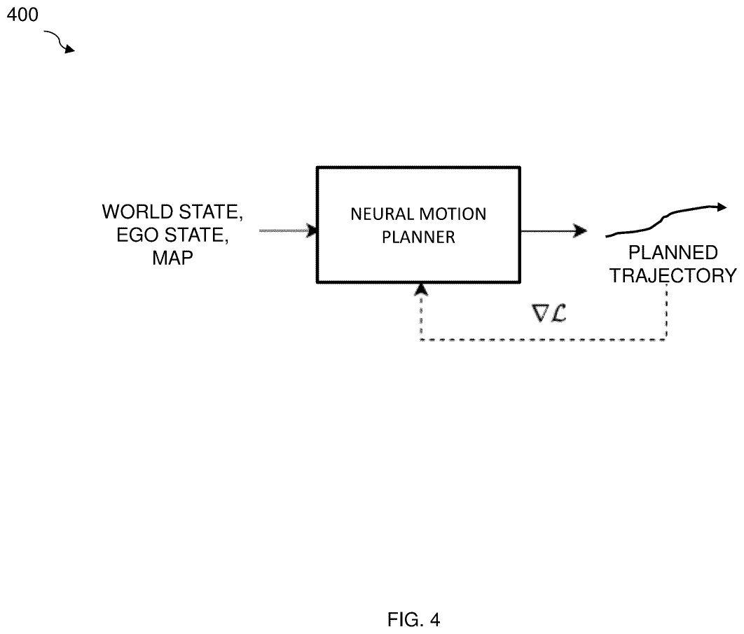

FIG. 4 illustrates an example of a neural motion planner that is trained using imitation learning with a UPC reward;

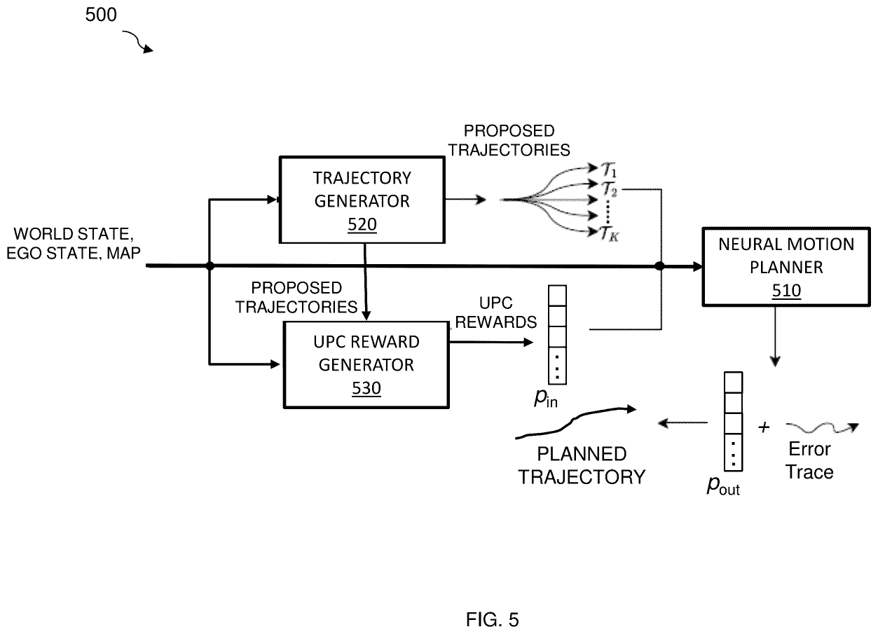

FIG. 5 illustrates an example of a motion planning system that integrates the UPC using explicit rule hierarchy injection;

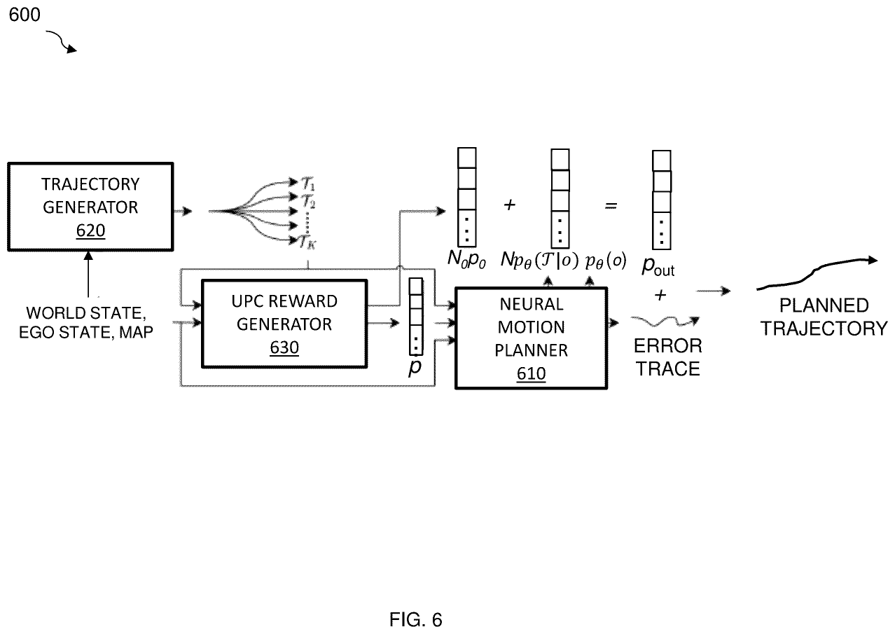

FIG. 6 illustrates another example of a motion planning system that integrates the UPC using explicit rule hierarchy injection via the UPC;

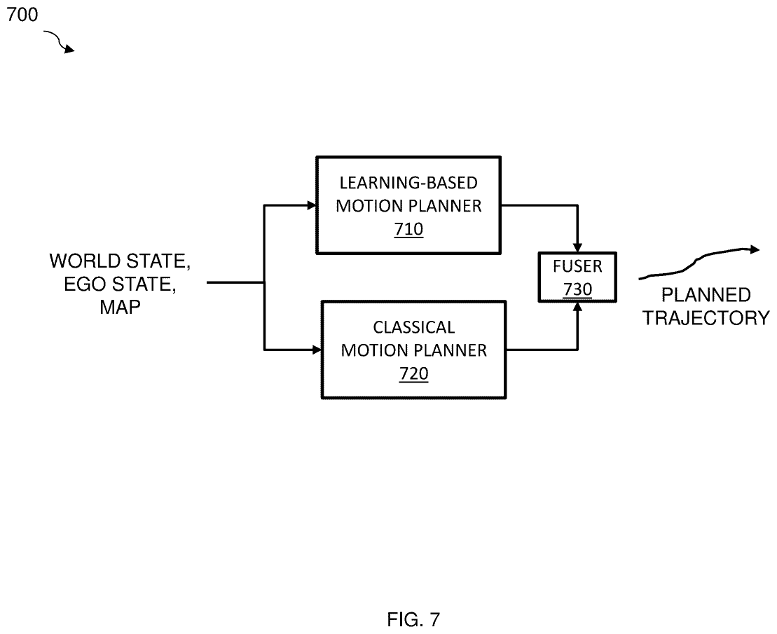

FIG. 7 illustrates another example of a motion planning system configured to use a UPC and operate according to the principles of the disclosure;

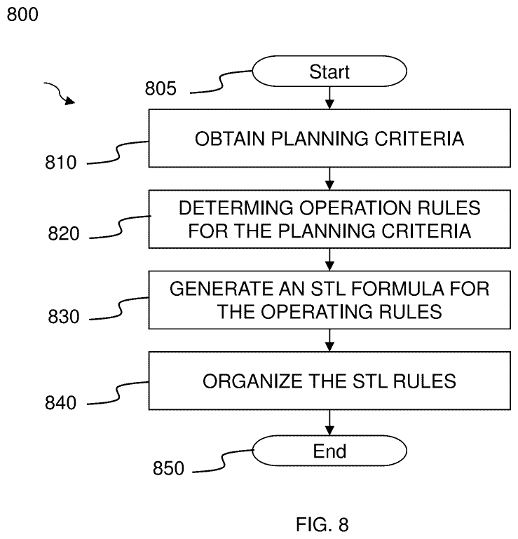

FIG. 8 illustrates a flow diagram of an example of a method of generating a digital representation of operating laws for an intelligent machine carried out according to the principles of the disclosure; and

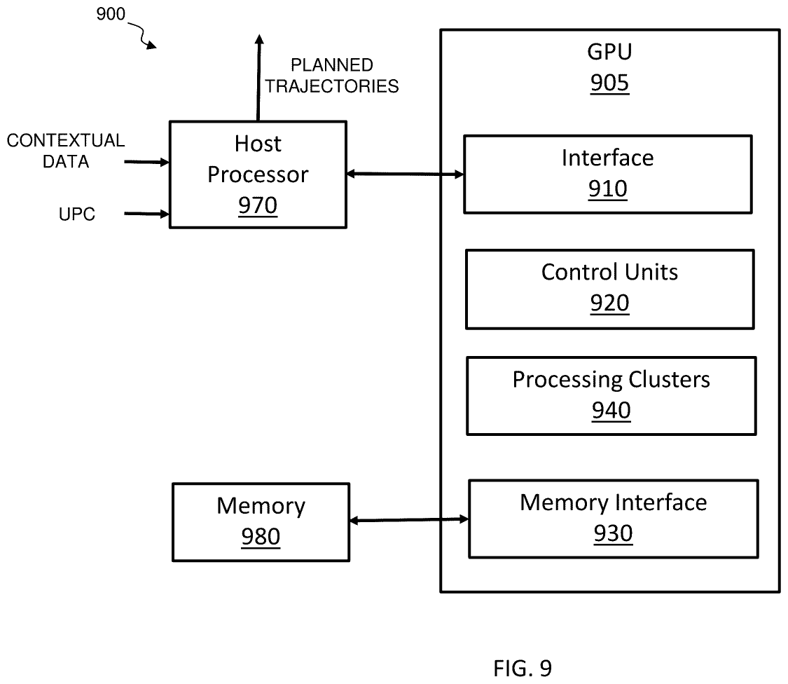

FIG. 9 illustrates a block diagram of an example of a computing system in which at least a portion of the disclosed systems, methods, or apparatuses disclosed herein can be implemented.

### DETAILED DESCRIPTION

Representing operating laws in motion planning for intelligent machines is challenging at least due to complex temporal rules and an innumerous variety of exceptions to the rules depending on the context, wherein the rules represent the salient aspects of the operating laws. For instance, translating traffic-laws into a format that can be used for motion planning poses at least two fundamental challenges: (i) traffic rules can often take the form of complex temporal specifications (e.g., stop at the stop-sign for at least 2-seconds, ensure that every other agent with the right-of-way before the ego has moved, then proceed through the intersection when safe to do so); (ii) traffic law allows numerous exceptions to satisfying the traffic rules under special circumstances (e.g., stopping in the middle of an intersection is prohibited unless it is necessary to avoid conflict with other traffic).

Various approaches have been attempted to express traffic laws for motion planning. Many of the approaches, however, have either been difficult to scale to the entire traffic law or do not provide a simple route allowing the use of hierarchies in the motion planning. Accordingly, expressing traffic laws in a manner amenable to motion planning has been an open problem; especially for neural motion planners.

While some approaches have attempted to inject traffic laws into motion planners, the approaches typically embed only a subset of the traffic rules without necessarily capturing the nuanced complexities. Furthermore, the attempted approaches do not appear to inject rule hierarchies in neural motion planners.

The disclosure provides a solution for AVs and other types of intelligent machines that incorporate operating laws into motion planning by expressing complex operating laws along with other planning criteria under a single framework referred to herein as universal planning criteria (UPC). The UPC framework, or simply UPC, is expressed using a rule hierarchy approach, which allows for expressing individual operating rules, such as traffic rules, as signal temporal logic (STL) rules that are assigned an importance order. The operating rules can be manually ordered or a learning-based processor can be used to place the rules in hierarchical order. The STL rule hierarchy is advantageously equipped with a scalar rank-preserving reward function that can be differentiable and can be explicitly used for motion planning and/or embedding in neural motion planners. One distinction between UPC and the other various approaches that have been attempted is that the UPC provides a way to scalably express the complex operating laws along with the other important planning criteria within a single unifying framework. For example, the UPC can scalably express complex traffic laws with such planning criteria as courtesy and ego objectives. FIG. 1 illustrates an example of such a UPC framework for AVs.

Furthermore, the UPC comes equipped with a reward function that measures compliance of agent trajectories to UPC, opening up various opportunities for planning and verification. Accordingly, the UPC can resolve the first challenge noted above for translating operating laws by, for example, expressing each rule as a STL rule. The UPC can resolve the second challenge by, for example, organizing the rules in the form of a hierarchy. The hierarchical criteria can then be transformed into a reward function which is monotonic in the importance of the criteria, i.e., if the planned trajectory satisfies higher importance rules then it receives a higher reward. The reward function will be referred to as UPC reward. Equations 1 and 2 provided below represent algorithms for generating the UPC reward, wherein Equation 1 provides a scalar reward function and Equation 2 provides a differential scalar reward function.

The scalar and differentiable UPC rewards can be used in many ways to embed, for example, traffic-law (and other planning criteria) within a learning-based planner, such as neural motion planners, to provide planned trajectories for AVs. Accordingly, complex traffic law specifications can be embedded in UPC (rule hierarchy) in neural motion planners. The neural motion planners can be, for example, learning-based motion planners that use a neural network and a machine learning algorithm, such as for unsupervised learning, supervised learning, reinforcement learning, or imitation learning. The UPC reward can additionally serve as a key performance indicator (KPI) for motion planners and for modeling a reasonable driver.

AVs and traffic laws are used herein in various examples. An AV as used herein includes the various levels of autonomy from Level 1 to Level 5, which include driver assistance, partial driving automation, conditional driving automation, high driving automation, and full driving automation. The representation of traffic laws, the neural motion planners, and other features disclosed herein can be implemented in the control systems for each of the vehicles, such as a vehicle control system. The driver-assistance system can be an advanced driver assistance system (ADAS).

The below examples use an ego AV as the intelligent machine and traffic laws as the operating laws. As noted above the UPC can also be used for other motion planning problems-regardless of the robotic platform—that encounters multiple, potentially conflicting criteria. Accordingly, the features of this disclosure can also be used in other intelligent machines or systems, including computer vision systems, robotic systems, or other types of autonomous, semi-autonomous, or technology assisted machines or devices.

The UPC is expressed using a rule hierarchy approach, which allows for expressing individual traffic rules as STL rules that are assigned an importance order. Regarding rule hierarchies, let x∈X be the state of a traffic agent (e.g., an ego AV) whose motion is being planned and y∈Y be the joint state of all traffic agents in a scene. Let x_{t:t+τ} and y_{t:t+τ} be the discrete-time state trajectories over some time duration from t to t+τ that lie in the space denoted by X′ and Y′, respectively. The scene map is described by a vector m that lies in the space of map features M.

The rules that the ego AV should satisfy are expressed as Boolean expressions ϕ: X′×Y′×M→0 {True, False} in the form of STL. A software tool for writing STL, such as STL Computation Graphs (STLCG) that is available as a Python toolbox, can be used to generate STL for the rules. Each STL rule is equipped with a robustness metric ρ: X′×Y′×M→R which returns positive values if the rule is satisfied and negative values otherwise, wherein larger positive robustness values indicate greater satisfaction of the rule while smaller negative values indicate greater violation.

A rule hierarchy φ can be defined as a sequence of rules φ: ={ϕᵢ}ᵢ₌₁ⁿ indexed in decreasing order of importance. The robustness vector τ∈Rⁿ of the rule hierarchy is defined as the vector ρ: =(ρ₁, ρ₂, . . . , ρₙ) of the individual robustness of each rule ϕᵢ. The rule hierarchy induces a ranking of trajectories in accordance with the importance of the rules they satisfy; trajectories that satisfy more important rules receive a superior rank than those that satisfy less important rules. For instance, for a 2-rule hierarchy {ϕᵢ}ᵢ₌₁², trajectories that: satisfy both rules have rank 1, satisfy ϕ₁ but violate ϕ₂ have rank 2, satisfy ϕ₂ but violate ϕ₁ have rank 3, and violate both rules have rank 4. Each rule hierarchy is endowed with a rank preserving reward function R: ρ=→R(ρ)∈ [symbol] that embodies the property: trajectories with a higher rank receive a higher reward than trajectories with a lower rank. Equation 1 provides an example of a rank-preserving reward function

$$R ( ρ ) := {\sum }_{i = 1}^{n} ( {a}^{n - i + 1} step ( {ρ}_{i} ) + \frac{{ρ}_{i}}{n} ) \qquad Equation l$$

where a >2. Furthermore, the rank-preserving reward function can be made differentiable by replacing the step functions with sigmoids as represented by Equation 2:

$$R ( p ) := {\sum }_{i = 1}^{n} ( {a}^{n - i + 1} s i g m o i d ( c {ρ}_{i} ) + \frac{{ρ}_{i}}{n} ) \qquad Equation 2$$

Considering the UPC as a rule hierarchy, FIG. 1 illustrates an example of a UPC 100 where there are three main planning criteria 110 for an ego AV to satisfy: traffic law 112, courtesy 114, and ego objectives 116. In this example, UPC 100 takes the form of a rule hierarchy with the importance order: traffic law 112>courtesy 114>ego objectives 116. Furthermore, each of the planning criteria can take the form of a rule hierarchy themselves. For example, FIG. 1 shows a traffic rule hierarchy 120 for traffic law 112 and a hierarchical sub-criteria 130 for courtesy 114. Each of the traffic rules of the traffic rule hierarchy 120 are represented by a distinct STL formula.

An objective or guiding principle can be used to order the rules in a rule hierarchy. For example, the guiding principle behind the order of the rules in the traffic rule hierarchy 120 and the hierarchical sub-criteria 130 in the UPC 100 is the traffic law principle that, simply put, prioritizes upholding the duty-of-care over exactly following the rules. Effectively, the rules of the traffic rule hierarchy 120 and the hierarchical sub-criteria 130 that have a higher potential of violating the duty-of-care to others has a higher priority.

The traffic law criteria is responsible for ensuring that the ego AV satisfies all the traffic rules of the traffic rule hierarchy 120 as dictated by the traffic law 112. The strength of expressing the traffic law 112 as a hierarchy of traffic rules arises from the ability to scalably express the desired outcomes for the various combinations of rule satisfactions that can be encountered. If all rules can be satisfied, that would be the preferred outcome. However, if they cannot, the traffic rule hierarchy 120 would automatically direct a motion planner, such as a neural motion planner, towards a solution that satisfies the more important rules at the expense of the less important ones, which can result in emergent ego AV behaviors from simple rule specifications.

For example, consider the stop sign rule mentioned earlier: stop at the stop-sign for at least 2-seconds, ensure that every other agent with the right-of-way before the ego AV has moved, then proceed through the intersection if safe to do so. Without a hierarchy, a motion planner would have to encode the enormous combination of situations that can arise; e.g., (i) ego AV stops for 2-seconds and the intersection is clear, so proceed, (ii) ego AV stops for 2-seconds, but the intersection is not clear, so wait; (iii) ego AV has not stopped for 2-seconds, intersection is clear, but there is an emergency vehicle behind the ego AV that requires the ego AV to move out to give space, etc.

With a hierarchy such as the traffic rule hierarchy 120, resolving the stop sign situation is significantly more straightforward than encoding the various combinations. Consider the traffic rule hierarchy 120 in FIG. 1: In scenario (i) all rules will be satisfied so the ego AV will stop at the intersection and then drive on; in scenario (ii) if the ego AV moves, it can violate the highest priority collision avoidance block, so it will continue to wait; in scenario (iii) if the ego AV stays put, it will violate the third rule (move out for emergency vehicles) of the traffic rule hierarchy 120, which has a higher importance than obeying the stop sign, so the ego AV should move, etc. Effectively, rule hierarchies such as the traffic rule hierarchy 120 provide a parsimonious yet rich representation of traffic laws, which is a key enabler to expressing and injecting traffic laws in an ego AV stack. Furthermore, rule hierarchies come equipped with a UPC reward, such as represented by Equations 1 and 2, which guides the selection of the best possible trajectory in accordance with the hierarchy.

The courtesy criteria 114 is tasked with ensuring that the ego AV drives with due consideration for other traffic agents. It is possible to follow the traffic rules of the hierarchical traffic rules 120 while being inconsiderate, which is what the courtesy criteria 114 explicitly aims to avoid. For instance, not giving space for traffic to merge into the highway is not illegal, but it is certainly not courteous. In FIG. 1, the courtesy criteria 114 has two hierarchical sub-criteria: considerate driving 132 and surprise minimization 134. Considerate driving 132 refers to driving in a manner so as not to force another agent into a state from which they cannot avoid a collision, i.e., always leaving viable options open for other traffic agents. Surprise minimization 134 refers to avoiding erratic driving that would surprise other traffic agents.

The ego objectives 116 include the ego's progression towards the goal and ensuring passenger comfort. The ego objectives can either be expressed as “flat” rewards that take the form of a weighted sum of the reward for each of these criterion or as a hierarchy whose order is largely dependent on the AV planning stack designers.

In addition to using a UPC to represent operating laws such as traffic laws, the disclosure also discloses integrating the operating laws via the UPC into neural motion planners, such as the motion planners represented in FIGS. 2 to 7. FIG. 2 illustrates a system having a motion planner, such as a neural motion planner.

FIG. 2 illustrates a block diagram of an example of a control system 200 for directing the operation of an intelligent machine according to the principles of the disclosure. The control system 200 includes a motion planner 210 and a control unit 220. The control system 200 can be a computing system that in located on or within the intelligent machine. The control system 200 can include additional components typically included in control systems for intelligent machines. For example, the control system 200 can include sensors and an interface that receives sensor data from the sensors. Additionally, the control system 200 can include an interface that communicates with other control systems or operational domains of the intelligent machine, such as a chassis domain, a powertrain domain, a steering domain or another operational domain that directs an operation or function of the intelligent machine. The control system 200 can be used in a classical motion planning stack. An intelligent machine can include control system 200, sensors that collect world scene data, one or more operational domains, and an interface that communicates between the control system 200, the sensors, and the operational domains. The control system 200 can be, for example, part of an autonomous driving and/or advance driving assistance system for an AV.

The motion planner 210 is configured to receive contextual data and generate a planned trajectory based on the contextual data and the UPC. The contextual data can include world scene parameters, machine state, and a scene map. The motion planner 210 can be a classical rules-based motion planner or a neural motion planner that use the UPC for generating the planned trajectory. FIGS. 3, 4, 5, and 6 provide examples of integrating a UPC in neural motion planners for ego AVs.

The control unit 220 is configured to provide commands, directions, or instructions to control the operation of the intelligent machine based on the planned trajectory. For example, the control unit 220 can be an electronic control unit that communicates with other domains of the intelligent machine. Considering an ego AV, the control unit 220 can provide directions to perform the actions of steering and accelerating the ego AV to follow the planned trajectory. Both the motion planner 210 and the control unit 220 can include one or more processing units, one or more memories, and one or more communications interfaces that are configured to cooperate and perform the disclosed functions, such as providing planned trajectories and directions to enable following the planned trajectories. FIG. 9 illustrates an example of a computing system that can be configured to perform the functions of the motion planner 210.

As noted above, FIGS. 3, 4, 5, and 6 provide examples of integrating a UPC in neural motion planners for ego AVs. Each of the neural motion planners can be used to generate a planned trajectory that can be provided to a control unit, such as control unit 220, to direct the operation of an ego AV.

FIG. 3 illustrates an example of a motion planning system 300 that uses Post-hoc Trajectory Pruning to obtain a planned trajectory. The motion planning system 300 can be integrated with an AV and provide planned trajectories in real time. For instance, the motion planning system 300 can be part of a vehicle control system, such as an ADAS. The motion planning system 300 includes a neural motion planner 310 and a pruning processor 320.

The pruning processor 320 can be a rules-based processor that performs a pruning process of proposed trajectories via UPC reward pruning. For example, the neural motion planner 310 generates multiple proposed trajectories and the pruning processor 320 assigns rewards to the different proposed trajectories based on satisfying and/or violating traffic rules of a traffic rule hierarchy, such as the traffic rules of traffic rule hierarchy 120. The pruning processor 320 can use the reward function represented by Equations 1 or 2 to assign rewards. The planned trajectory can be selected from the proposed trajectories based on the rewards. The pruning processor 320 can simply select the proposed trajectory with the highest reward value or via another process, such as reward value and probability of occurrence

Neural motion planner 310 is trained to generate K A V motion plans {Tᵢ}^{K}ᵢ₌₁ i.e., proposed trajectories. For example, neural motion planner 310 can take the form of a conditional variational autoencoder for generating the proposed trajectories. Rank-preserving reward Ri can be computed by the pruning processor 320 using Equation 1 or 2 for each of the proposed trajectories and either: (a) select the one with the highest reward or (b) create a discrete Boltzmann distribution over the proposed trajectories using the rewards Ri as the negative of the Boltzmann energy according to Equation 3 below:

$${p}_{i} = \frac{exp ( {R}_{i} / ζ )}{{\sum }_{i = 1}^{K} exp ( {R}_{i} / ζ )} , \qquad Equation 3$$

where ζ>0 is the temperature of the Boltzmann distribution, controlling the degree of optimality expected from real-world agents with respect to the chosen rule hierarchy.

In FIG. 3, the UPC is integrated with the neural motion planner 310 via the pruning process performed by the pruning processor 320. In FIG. 4, an example of integrating a UPC with a neural motion planner via training is presented. The trained neural motion planner can then be used in a control system for a vehicle, such as the control system 200 and the motion planning system 300.

FIG. 4 illustrates an example of a neural motion planner 400 that is trained using imitation learning with a UPC reward. The neural motion planner 400 is trained to mimic human driver data while also adhering to the UPC (ergo traffic law) by minimizing a loss function. An example loss function can take the following form represented by Equation 4:

$$ℒ = {ℒ}_{imitation} + α {ℒ}_{UPC} , \qquad Equation 4$$

where α>0 is a positive weight. Any popular Lᵢₘᵢₜₐₜᵢₒₙ loss Limitation can be used. The UPC loss can be created by composing any positive scalar function that is monotonically decreasing such as represented by Equation 5:

$$\hat{R} , i . e . , {ℒ}_{UPC} = v ( \hat{R} ) where v : ℝ \to [ 0 , ∞ ] . \qquad Equation 5$$

An instantiation of such a loss can be represented by Equation 6:

$${ℒ}_{UPC} = exp ( - β R ) where β > 0. \qquad Equation 6$$

For FIG. 4, the differentiability of \hat{R} from Equation 2 facilitates back propagating through this loss for training.

The integration of the UPC represented in FIG. 3 essentially occurs after operation of the respective neural motion planners via either pruning or training. In FIGS. 5-6, the rule hierarchy of the UPC is explicitly injected in neural motion planners. As with FIG. 4, FIGS. 5-6 illustrate training configurations for neural motion planners that incorporate the UPC. The systems of FIGS. 4-5 can also be used in real time as part of a vehicle control system. For example, the UPC reward generation and the trajectory generation can be leveraged via GPU parallelization.

FIG. 5 illustrates an example of a motion planning system 500 that integrates the UPC using explicit rule hierarchy injection. Motion planning system 500 includes neural motion planner 510, a trajectory generator 520, and a UPC reward generator 530. Unlike the approach used with the motion planning system 300, which performs late stage pruning of trajectories according to UPC, neural motion planner 510 is informed a priori of the traffic law and other planning criteria.

For example, contextual data is provided to the neural motion planner 510, the trajectory generator 520, which generates proposed trajectories therefrom, and the UPC reward generator 530. The UPC reward generator 530, which also receives the proposed trajectories, computes a UPC reward for all the proposed trajectories and sends the UPC rewards, which are used similar to probability weights, to the neural motion planner 510. The neural motion planner 510, therefore, can make more context aware decisions, and possibly require less data for training. Accordingly, the proposed trajectories and the corresponding rewards are conditioned on the contextual data, which represents the current situation of the vehicle and assists in selecting a proposed trajectory. Additionally, an error trace is generated by the neural motion planner 510 that can be used to modify the selected proposed trajectory to obtain the planned trajectory.

The neural motion planner 510 can be informed a priori of the traffic law and other planning criteria by supplying it with a motion primitive tree {Tᵢ}^{K}ᵢ₌₁ with K branches and a probability vector pᵢₙ computed by the UPC reward generator 530 using the reward Rᵢ as was done in Equation 3 (or alternatively the rewards Rᵢ as is). The trajectory generator 520 generates the motion primitive tree of proposed trajectories for the neural motion planner 510 and the UPC reward generator 530 generates the probability vector pᵢₙ.

Early rule injection incentivizes the neural motion planner 510 to proactively synthesize traffic-law abiding trajectories and avoid scenarios where no generated trajectory satisfies the traffic law, as could occur with the approach used with motion planning system 300. The motion planning system 500 provides a planning network wherein the neural motion planner 510 is trained to predict both a probability vector pₒᵤₜ, which scores the input trajectories, and an error trace. The neural motion planner 510 selects trajectory with the highest probability is chosen and the error trace is added to it to generate the actual planned trajectory. The error trace is an adjustment generated by the neural network of the neural motion planner 510 that is added to the chosen trajectory from the trajectory tree. The error trace allows the generation of trajectories beyond the proposed trajectories from the trajectory tree. Without the error trace, the final planned trajectory is limited to just the trajectories in the trajectory tree.

Reframing the planning problem for an ego AV or other intelligent machine as a classification problem over a set of base trajectories, such as used with the motion planning system 500, has several advantages. First, the shared trajectory tree serves as a common representation point that is compatible with both the UPC reward model, as well as a neural motion planner. Furthermore, outputting probability vectors allows encoding uncertainty information, e.g. by using the entropy to detect out-of-distribution (OOD) scenarios. The UPC probability vector can also be viewed a prior, and regularize the output of the neural motion planner towards this prior, by, for example, adding a weighted contrastive loss between the probability vectors (e.g. a dot product).

This Bayesian perspective also suggests an alternative approach to explicit rule hierarchy injection, summarized in FIG. 6. FIG. 6 illustrates another example of a motion planning system 600 that integrates the UPC using explicit rule hierarchy injection via the UPC. Motion planning system 600 includes neural motion planner 610, trajectory generator 620, and UPC reward generator 630. As with the motion planning system 500, in motion planning system 600 the neural motion planner 610 is informed a priori of the traffic law and other planning criteria via UPC rewards computed by the UPC reward generator 630. The neural motion planner 630 also receives contextual data, along with the trajectory generator 620 and the UPC reward generator 630, allowing more context aware decisions.

The neural motion planner 630 generates an output that is a conditional probability distribution that indicates which of the trajectory tree options are the most likely in view of observations based on the contextual data. Additionally, the neural motion planner 630 generates an independent assessment of the likelihood of the observations, which represents the similarity of an observation to the training data used to train the neural motion planner 630. By generating both of these outputs, the neural motion planner 630 provides the ability to scale the influence of a trained model. As such, a difference between the motion planning systems 500 and 600 is that the motion planning system 600 allows modulation of the influence of the neural motion planner 630 over the UPC baseline based on an estimate of the similarity between the contextual data and the training data used in training of the neural motion planner 630. Accordingly, when the neural motion planner 630 encounters contextual data in real time that was not represented in the training data, then instead of relying on the neural motion planner 630 to make a good prediction, the motion planning system 600 can revert to a suggestion based on the UPC. Thus, the motion planning system 600 provides a training and operating architecture that can allow how much the neural motion planner 630 can sway the final probabilities over the trajectory trees.

In the motion planning system 600, a trajectory tree of proposed trajectories is generated by trajectory generator 620, such as generated by trajectory generator 520. The UPC reward generator 630 computes probabilities for each of the trajectories from the trajectory tree under the UPC such as represented in Equation 3. Unlike motion planning system 500, however, rather than interpret these as direct probabilities, the probabilities are extended and treated as a pseudocounts of a Dirichlet prior and provided as rule robustness p for each of the proposed trajectories. Next, the trajectory tree, contextual data including world state, as well as the rule robustness ρ for each trajectory is provided to the neural motion planner 610, which now is tasked to estimate two quantities: (1) conditional class probabilities ρ_{θ}( [symbol] |o), and (2) an estimate of the input likelihood ρ_{θ}(o), where o is all the contextual data provided as input to the neural motion planner 610. These two quantities determine an additive adjustment to the pseudocounts, which define a posterior Dirichlet distribution over predictions. The conditional likelihood can be trained with a standard classification objective, while the input likelihood can be modeled via techniques such as normalizing flows in the latent space of the neural motion planner 610. This configuration, which can be used for training, ensures that when an input is out-of-distribution, i.e. p_{θ}(o) is small, the predictions will revert to those specified by the prior pseudocounts, i.e., the rule hierarchy predictions. The neural motion planner 610 is trained to predict both a probability vector pₒᵤₜ, and an error trace, wherein the probability vector pₒᵤₜ scores the input trajectories and is a combination of the conditional class probabilities p_{θ}( [symbol] |o), and the estimate of the input likelihood p_{θ}(o). The neural motion planner 610 selects a trajectory with the highest probability and the error trace is added to it to generate the actual planned trajectory.

Overall, the motion planning system 600 automatically regularizes the predicted plans to cluster around trajectory modes that satisfy rules, but allows the neural motion planner 610 to adjust relative likelihoods based on statistical trends for scenarios with high representation in the training data, and cleanly reverts to the rule-hierarchical model predictions on OOD scenarios where the neural motion planner 610 is likely to be incorrect. The training data, for example, is the contextual data and the actual trajectory data of an intelligent machine during data collection.

Other variants of the approach provided by the motion planning system 600 includes outputting a new trajectory directly from the neural motion planner 610 without any probability scores or generating only a single error trace rather than one for each branch of the input trajectory tree.

FIG. 7 illustrates another example of a motion planning system 700 configured to use a UPC and operate according to the principles of the disclosure. Like the motion planners 300, 400, 500, and 600, motion planning system 700 also includes a neural motion planner, which is denoted as neural motion planner 710. The neural motion planner 710 can be, for example, any of the neural motion planners disclosed in FIGS. 3-6 that have been trained. Additionally, motion planning system 700 includes a classical rule-based motion planner 720 that maximizes the UPC reward, such as represented by Equation 1 or 2, in parallel to the neural motion planner 710. The output trajectories of both are then fused via a fusion node 730 to generate a final planned trajectory. The fusion node 730 can take various forms: (i) selection of the trajectory with the best UPC satisfaction; (ii) a neural ranker that learns to score and rank these trajectories according to some criteria (e.g., human preference) and chooses the one with highest predicted rank; (iii) maintaining a belief distribution on the two models based on their historical performance according to UPC and sampling trajectories in accordance with the belief distribution, ‘a la multi-predictor fusion.

For example, a review of the historical performance of both the neural motion planner 710 and the classical motion planner 720 over a selected amount of time, such as in the range of one to five seconds, may indicate that the neural motion planner 710 was performing better than the classical motion planner 720, As such, the fuser 730 could rely more on the neural motion planner 710 when fusing to obtain the planned trajectory.

The neural motion planner 710 and the classical motion planner 720 provide an ensemble of models used by the motion planning system 700 that can exhibit good performance in different data regimes. For example, if the classical motion planner 720 is unable to reason about other agents’ behaviors correctly or gets stuck on a local minima, the neural motion planner 710 can come to the rescue. On the other hand, if the neural motion planner 710 encounters an OOD scenario, the classical motion planner 720 can improve performance.

FIG. 8 illustrates a flow diagram of an example of a method 800 of generating a digital representation of operating laws for an intelligent machine carried out according to the principles of the disclosure. One or more of the steps of method 800 can be carried out by a series of operating instructions that cause at least one processor to implement one or more of the steps. The series of operating instructions correspond to one or more algorithms and can be stored on a non-transitory computer-readable medium. For example, the one or more algorithms can be directed to the rule hierarchies and Equations 1-2 discussed above regarding FIG. 1. At least a portion of the method 800 can be performed by a computing system, such as computing system 900 of FIG. 9. An example of the operating laws and intelligent machine are traffic laws and an ego AV. The method 800 start in step 805.

In step 810, a planning criteria for operating the intelligent machine is obtained and placed in hierarchical order. The planning criteria can include operating laws, courtesy goals, and operating objectives for the intelligent machine. The planning criteria can be manually created, generated by one or more computers, or created using a combination thereof. FIG. 1 illustrates an example of planning criteria 100 for an ego AV.

Operating rules for one or more of the different criterions of the planning criteria are determined in step 820. The operating rules can be determined manually, generated via one or more processors, such as by machine learning, or a combination thereof. FIG. 1 illustrates an example of traffic rules and hierarchical sub-criteria for traffic laws and courtesy goals.

In step 830, a STL formula for each of the operating rules is generated using one or more processors. A software tool can be used with the one or more processors for writing the STL. STLCG is one example of a software tool that can be used.

The STL represented operating rules are then organized into a hierarchy in step 840. The STL represented operating laws can be organized manually, using one or more computers, or a combination of both. FIG. 1 illustrates traffic rules 120 that are organized in hierarchical order.

The method 800 ends in step 850 with the creation of the digital representation, referred to herein as a UPC. FIG. 1 visually represents a UPC for an ego AV. The digital representation can be integrated with a neural motion planner and a control system for operating an intelligent machine.

FIG. 9 illustrates a block diagram of an example of a computing system 900 in which at least a portion of the disclosed systems, methods, or apparatuses disclosed herein can be implemented. For example, computing system 900 can be used for the motion planning systems and motion planners disclosed herein that generate planned trajectories for intelligent machines. Computing system 900 provides an example of a parallel processing unit, GPU 905, included in a system with one or more other devices. Computing system 900 can be embodied on a single semiconductor substrate and can include other devices such as additional GPUs. GPU 905 can be coupled to the additional GPUs via one or more interconnects, such as high-speed interconnects. In FIG. 9, GPU 905 is coupled to a host processor 970 and a memory 980. Host processor 970 can be a CPU and memory 980 can include multiple memory devices. GPU 905 includes an interface 910, control units 920, a memory interface 930, and processing cluster 940. GPU 905 can include additional components that are not illustrated but typically included in a GPU, such as communication busses and interconnects.

Interface 910 is an input and output interface configured to communicate data, commands, and other information, with external components, such as host processor 970. Interface 910 can transmit and receive data and commands over conventional interconnects. Interface 910 can receive, for example, contextual data and UPC via the host processor 970. Instead of receiving the UPC, the interface 910 can receive planning criteria that is used to generate the UPC. Received communications can be sent to the various components of GPU 905, such as control units 920. Control units 920 are configured to manage processing streams, configure processing cluster 940 for processing tasks defined by the streams, distribute the tasks to processing cluster 940, and manage the execution of the tasks on processing cluster 940. The results generated by the tasks can be directed to memory interface 930. Memory interface 930 is configured to store the results in a memory, such as memory 980. The tasks can be directed to determining planned trajectories for intelligent machines as carried out, for example, by one or more of the motion planning systems or motion planners disclosed herein. The results can be the planned trajectories that can also be provided to another system, such as control unit 220, to use for generating commands to direct the operation of an intelligent machine. The planned trajectories can be output via the host processor 970 as shown in FIG. 9.

In addition to writing to memory 980, memory interface 930 is also configured to read data from memory 980. Memory 920 can store a series of operating instructions corresponding to one or more algorithms that when executed, cause the processing cluster 940 to generate planned trajectories. The one or more algorithms can correspond to one or more of the Equations 1 to 6 and generation of the rule hierarchies as discussed with respect to FIG. 1. The memory 980 can store, for example, a trained NN for motion planning. The memory 980 can also store a UPC. The memory 980 can be a non-transitory computer readable memory.

Processing cluster 940 includes multiple processing cores for processing the tasks. The processing cores can be optimized for matrix math operations and can be employed for training NNs, such as the neural motion planners disclosed herein. A training data set includes the contextual data and the actual trajectory data of an intelligent machine during data collection. Processing cluster 940 can include a pipeline manager that directs the operation of the processing cores for parallel processing of the tasks. Processing cluster 940 can also include additional components for processing the tasks, such as a memory management unit.

A portion of the above-described apparatus, systems or methods may be embodied in or performed by various digital data processors or computers, wherein the computers are programmed or store executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

The digital data processors or computers can be comprised of one or more GPUs, one or more CPUs, one or more of other processor types, or a combination thereof. The digital data processors and computers can be located proximate each other, proximate an intelligent machine such as an AV, in a cloud environment, a data center, or located in a combination thereof. For example, some components can be located proximate the intelligent machine, such as a trained neural motion planner, and some components can be located in a cloud environment or data center, such as a neural motion planner that is being trained.

The GPUs can be embodied on a single semiconductor substrate, included in a system with one or more other devices such as additional GPUs, a memory, and a CPU. The GPUs may be included on a graphics card that includes one or more memory devices and is configured to interface with a motherboard of a computer. The GPUs may be integrated GPUs (iGPUs) that are co-located with a CPU on a single chip.

The processors or computers can be part of GPU racks located in a data center. The GPU racks can be high-density (HD) GPU racks that include high performance GPU compute nodes and storage nodes. The high performance GPU compute nodes can be servers designed for general-purpose computing on graphics processing units (GPGPU) to accelerate deep learning applications. For example, the GPU compute nodes can be servers of the DGX product line from NVIDIA Corporation of Santa Clara, California.

The compute density provided by the HD GPU racks is advantageous for AI computing and GPU data centers directed to AI computing. The HD GPU racks can be used with reactive machines, autonomous machines, self-aware machines, and self-learning machines that all require a massive compute intensive server infrastructure. For example, the GPU data centers employing HD GPU racks can provide the storage and networking needed to support large-scale neural network (NN) training, such as for the NNs disclosed herein used for neural motion planners. The NNs can be Deep Neural Networks (DNN).

The NNs disclosed herein include multiple layers of connected nodes that can be trained with input data to solve complex problems. For example, contextual data, UPC, proposed trajectories, or a combination thereof can be used as input data for training of the NN. Once the NNs are trained, the NNs can be deployed and used to generate planned trajectories.

In one example of training, data flows through the NNs in a forward propagation phase until a prediction is produced that indicates a label corresponding to the input. When the NNs do not correctly label the input, errors between the correct label and the predicted label are analyzed, and the weights are adjusted for features of the layers during a backward propagation phase that correctly labels the inputs in a training dataset. With thousands of processing cores that are optimized for matrix math operations, GPUs such as noted above are capable of delivering the performance required for training NNs for artificial intelligence and machine learning applications.

Portions of disclosed embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Examples of program code include both machine code, such as produced by a compiler, and files containing higher level code that may be executed by the computer using an interpreter. Configured or configured to means, for example, designed, constructed, or programmed, with the necessary logic, algorithms, processing instructions, and/or features for performing a task or tasks.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

It is noted that as used herein and in the appended claims, the singular forms “a”, “an”, and “the” include plural referents unless the context clearly dictates otherwise.

Various aspects of the disclosure can be claimed including the systems and methods. Each of the independent claims provided below may have one or more of the elements of the dependent claims presented below in combination.

Those skilled in the art to which this application relates will appreciate that other and further additions, deletions, substitutions and modifications may be made to the described embodiments.

What is claimed is:

1. A method of operating an autonomous vehicle (AV), comprising:
scalably expressing traffic laws and additional planning criteria in a universal planning criteria (UPC) framework; and
generating, using a neural motion planner and the UPC framework, a planned trajectory for the AV.

2. The method as recited in claim 1, wherein the scalably expressing includes expressing each rule of the traffic laws as a signal temporal logic (STL) formula.

3. The method as recited in claim 2, wherein the rules are organized in the form of a hierarchy.

4. The method as recited in claim 3, wherein the scalably expressing further includes transforming the rules into a differentiable scalar reward function.

5. The method as recited in claim 1, wherein the neural motion planner uses a post-hoc trajectory pruning method.

6. The method as recited in claim 1, wherein the neural motion planner uses an imitation learning method with a UPC reward.

7. The method as recited in claim 1, wherein the neural motion planner uses explicit rule hierarchy injection.

8. The method as recited in claim 7, wherein the injection is a direct injection.

9. The method as recited in claim 7, wherein the injection is a Bayesian injection.

10. The method as recited in claim 1, wherein the planned trajectory is a first planned trajectory and the generating further includes generating a second planned trajectory using a classical motion planner, fusing the first and second planned trajectories, and providing a third planned trajectory based on the fusing.

11. The method as recited in claim 1, further comprising directing operation of the AV using the planned trajectory.

12. A method of operating a machine, comprising:
representing operating laws in motion planning for the machine by scalably expressing the operating laws and other planning criteria in a UPC framework and embedding the UPC in a neural motion planner;
generating planned trajectories by the neural motion planner using the UPC; and
operating the machine using the planned trajectories.

13. The method as recited in claim 12, wherein the operating laws are traffic laws and the machine is an autonomous vehicle.

14. The method as recited in claim 13, wherein the scalably expressing includes expressing each rule of the traffic laws as a signal temporal logic (STL) formula.

15. The method as recited in claim 14, wherein the rules are organized in the form of a hierarchy.

16. The method as recited in claim 15, wherein the scalably expressing further includes transforming the rules into a differentiable scalar reward function.

17. The method as recited in claim 12, wherein the embedding is explicit.

18. The method as recited in claim 12, wherein the embedding is via a UPC probability vector.

19. The method as recited in claim 12, wherein the embedding is via a UPC rule robustness vector.

20. The method as recited in claim 12, wherein the embedding is via a pruning process of proposed trajectories.

21. The method as recited in claim 12, wherein the machine is a robot.

22. A control system for a machine, comprising:
one or more processing units configured to generate planned trajectories for the machine based on learning and operating laws for the machine represented by a UPC; and
a control unit configured to receive the planned trajectories and direct operation of the machine based on the planned trajectories.

23. The control system as recited in claim 22, wherein the one or more processing units are integrated within a neural motion planner.

24. The control system as recited in claim 22, where the one or more processing units include a graphics processing unit.

25. The control system as recited in claim 22, wherein the machine is an autonomous vehicle.

26. The control system as recited in claim 22, wherein the one or more processing units generate the planned trajectories in real time and the control unit directs operation of the machine in real time based on the planned trajectories.

27. A computer program product having a series of operating instructions stored on a non-transitory computer-readable medium that directs a data processing apparatus when executed thereby to perform operations to direct operation of an intelligent machine, the operations comprising:
scalably expressing traffic laws and additional planning criteria in a universal planning criteria (UPC) framework, wherein the scalably expressing includes expressing each rule of the traffic laws as a signal temporal logic (STL) formula;
generating, using a neural motion planner and the UPC framework, planned trajectories for the intelligent machine; and
directing movement of the intelligent machine using the planned trajectories.

28. The computer program product as recited in claim 27, wherein the intelligent machine is an autonomous vehicle.

29. A machine, comprising:
one or more operational domains;
a motion planner having one or more neural networks configured to generate planned trajectories for the machine based on operating laws for the machine represented by a universal planning criteria; and
a control unit having one or more processors configured to receive the planned trajectories and direct operation of the one or more operational domains using commands based on the planned trajectories.

30. The machine as recited in claim 29, wherein the one or more operational domains include at least one of a chassis domain, a powertrain domain, or a steering domain.
